(19) United States
(12) Patent Application Publication
(10) Pub. No.: US 2005/0219220 A1
(43) Pub. Date: Oct. 6, 2005

(54) Electronic device

(75) Inventors: Nobuya Kishi, Yamatokoriyama-shi (JP); Takaya Nakatani, Habikino-shi (JP); Kenichiro Imayoshi, Souraku-gun (JP); Yosuke Kashu, Kitakatsuragi-gun (JP); Takateru Yamamoto, Uji-shi (JP)

Correspondence Address: EDWARDS & ANGELL, LLP, P.O. BOX 55874, BOSTON, MA, 02205, US

(73) Assignee: Sharp Kabushiki Kaisha

(21) Appl. No.: 11/075,789

(22) Filed: Mar. 7, 2005

(30) Foreign Application Priority Data
Mar. 30, 2004 (JP) 2004-101217

(51) Int. Cl. G09G 5/08

(52) U.S. Cl. 345/169

(57) ABSTRACT

When a standby state is released, the attitude detector detects its own attitude, and a display style of key identification images assigned to the respective input keys and an image to be displayed on the display unit is determined based on the detection result. Then, set values fitting the display style are read from a display table and a key arrangement table, and switching of control is performed. Next, when switching of control is determined to be completed, the key identification images and output image are displayed in the set display style, and the display direction is optimized. Thus, the display style of the key identification images that are indicators for identifying input keys and the output image displayed on the display unit is automatically optimized according to the attitude.

### CROSS-REFERENCE TO RELATED APPLICATION

This non-provisional application claims priority under 35 U.S.C. §119(a) on Patent Application No. 2004-101217 filed in Japan on Mar. 30, 2004, the entire contents of which are hereby incorporated by reference.

### BACKGROUND OF THE INVENTION

1. Field of the Invention

The present invention relates to an electronic device capable of changing the display style of an image, according to its own attitude.

2. Description of Related Art

There are demands for light-weight and multifunction mobile information terminal devices (hereinafter referred to as mobile terminals) such as mobile phones and PDAs (Personal Digital Assistants). For example, an increasing number of mobile phones have a phone book function, an electronic mail function, an Internet connection function, a camera function and so on in addition to the fundamental telephone function. Therefore, the operation unit of a mobile phone has various types of input keys such as character keys for inputting alphabet, and function keys for selecting functions in addition to numerical keys for inputting telephone numbers.

Moreover, the mobile phone has a display unit incorporating a display device such as a liquid crystal display to display a variety of information. Examples of the information to be displayed on the display unit include telephone numbers inputted by a user, a phone book, electronic mails, images and pictures downloaded from Internet networks, and images obtained by taking photographs with a digital camera attached to the mobile phone, and thus the contents to be displayed are diversified. Hence, there may be a case where the content to be displayed on the display unit can be more easily seen by the user by displaying it on a wide screen rather than on a long screen. In recent years, therefore, a mobile terminal to which a display unit is attached so that it can freely turn to make it possible to change the display direction of an image according to the orientation of the display unit was proposed, and a mobile terminal capable of detecting the attitude of the display unit and switching between a horizontal writing display and a vertical writing display according to the detection results was proposed (see, for example, Japanese Patent Application Laid-Open No. 2000-59474).

In the mobile terminal with the display unit that can turn with respect to the operation unit, since the orientation of the operation unit itself does not change, such a mobile terminal has an advantage that the feeling of operating the operation unit does not change even when the display unit is turned. However, since the size of a mechanism for turning the display unit is large, such a mobile terminal has a problem that the size of the mobile terminal itself cannot be decreased.

On the other hand, in the mobile terminal capable of switching between a horizontal writing display and a vertical writing display according to the attitude of the display unit, only the direction of displaying an image on the display unit is changed, and consequently the direction of displaying numerals for identifying input keys of the operation unit and indicators such as marks for identifying keys is changed, and it becomes hard to see the keys. Therefore, such a mobile terminal has a problem that the feeling of operating the operation unit in the above-mentioned condition is considerably bad. In particular, if the operation unit is positioned on the right side with respect to the display unit as a result of switching the display direction of the display unit, it is extremely hard for a left-handed user to operate the mobile terminal. In order to avoid such a circumstance, the user needs to intentionally change the display direction, and consequently there arises a problem of a further decrease in convenience.

### BRIEF SUMMARY OF THE INVENTION

The present invention has been made with the aim of solving the above problems, and it is an object of the present invention to provide an electronic device capable of optimizing the display style of indicators assigned to the respective input keys to identify the keys, without increasing the size of the device.

Plainly speaking, in order to achieve such an object, the present invention constructs an electronic device as a mobile information terminal device such as a mobile phone and a PDA so that it detects its own attitude, automatically sets a display style of indicators for identifying keys which are displayed corresponding to the positions of the respective input keys, according to the detection result of the attitude, and displays the indicators for identifying keys in the set display style.

An electronic device of the present invention is basically an electronic device which comprises: a key identification image display unit displaying key identification images for identifying input keys; one or a plurality of key tops arranged on the key identification image display unit and formed so that a display shown by the key identification display unit is visible; and a control unit for causing key identification images for identifying the respective key tops to be displayed on the key identification image display unit according to positions where the respective key tops are arranged on the key identification image display unit and for performing a process according to information inputted by pushing the key top, characterized by comprising an attitude detector for detecting its own attitude, wherein the control unit sets a display style of the key identification images based on detection result of the attitude detector, and displays the key identification images in the set display style.

In such an electronic device of the present invention, the display style of key identification images assigned to the respective input keys is automatically optimized according to the detected attitude of the electronic device.

Therefore, according to the above-mentioned electronic device of the present invention, since the display style of the key identification images assigned to the respective input keys is automatically optimized according to the detected attitude, it is possible to prevent deterioration of the operating feeling even when the electronic device is handled in any attitude.

Another electronic device of the present invention is based on the above-mentioned electronic device, and further characterized by further comprising an output image display unit for displaying an output image outputted based on information inputted by pushing the key top, wherein the control unit generates the output image based on the information inputted by pushing the key top, sets a display style of the output image on the output image display unit based on the detection result of the attitude detector, and displays the generated output image in the set display style on the output image display unit.

Such an electronic device of the present invention enables the above-mentioned electronic device to automatically optimize the display style of an output image to be displayed on an output image display unit, according to the detected attitude.

Therefore, according to such an electronic device of the present invention, the above-mentioned electronic device can display the output image in the state in which the image can be easily seen by the user even when the electronic device is handled in any attitude.

Another electronic device of the present invention is based on the above-mentioned electronic device, and further characterized in that the attitude detector comprises: at least one electrode connected to a power source; a conductive movable piece moving in a movable range in which it is capable of coming into contact with the electrode, according to a change of its own attitude; and a detection circuit for detecting a conductive state between the electrode and the movable piece, whereby the attitude detector detects its own attitude based on the conductive state detected by the detection circuit.

Such an electronic device of the present invention enables the above-mentioned electronic device to detect its own attitude by an attitude detector with a simple structure.

Therefore, according to such an electronic device of the present invention, even though the attitude detector is further incorporated into the above-mentioned electronic device, it is possible to limit the increase in the cost and it is possible to avoid an increase in the size of the device.

Another electronic device of the present invention is based on the above-mentioned electronic device, and further characterized in that, when the detection circuit detects that the electrode and the movable piece are conductive state, the control unit sets a display style of the key identification images and the output image so that the key identification images and the output image are displayed on the key identification image display unit and the output image display unit, respectively, in a predetermined positional relationship.

Such an electronic device of the present invention enables the above-mentioned electronic device to automatically optimize the display style of the key identification images and output image, according to the detected attitude.

Therefore, according to such an electronic device of the present invention, in the above-mentioned electronic device, even when the electronic device is handled in any attitude, the output image is displayed in the state in which the image can be easily seen, and it is possible to prevent deterioration of the operating feeling. Moreover, by setting this state as a default, it is possible to limit the increase in power consumption due to the incorporation of the attitude detector.

Another electronic device of the present invention is based on the above-mentioned electronic device, and further characterized in that, when the detection circuit detects that the electrode and the movable piece are not conductive state, the control unit sets a display style of the key identification images and the output image so that the key identification images and the output image are displayed on the key identification image display unit and the output image display unit, respectively, in a positional relationship different from the predetermined positional relationship.

Such an electronic device of the present invention enables the above-mentioned electronic device to automatically optimize the display style of the key identification images and output image, according to the detected attitude.

Therefore, according to such an electronic device of the present invention, in the above-mentioned electronic device, even when the electronic device is handled in any attitude, the output image is displayed in the state in which the image can be easily seen, and it is possible to prevent deterioration of the operating feeling.

Another electronic device of the present invention is based on the above-mentioned electronic device, and further characterized by further comprising a memory for storing a plurality of sets of corresponding relationship between the respective key tops and key identification images assigned to the respective key tops, which prescribe display styles of the key identification images, wherein the control unit selects one set of corresponding relationship stored in the memory based on the detection result of the attitude detector, and sets a display style of the key identification images according to the selected corresponding relationship.

Such an electronic device of the present invention enables the above-mentioned electronic device to change the display style without executing image processing.

Therefore, according to such an electronic device of the present invention, in the above-mentioned electronic device, it is further possible to reduce the time required for switching the display.

Another electronic device of the present invention is based on the above-mentioned electronic device, and further characterized in that the display style of the output image is regulated by rotating, enlarging or reducing the output image.

According to such an electronic device of the present invention, in the above-mentioned electronic device, the display style is regulated by rotating, enlarging or reducing the output image.

Therefore, according to such an electronic device of the present invention, in the above-mentioned electronic device, it is further possible to display the output image according to the attitude and size of the output image display unit.

Another electronic device of the present invention is based on the above-mentioned electronic device, and further characterized by further comprising a touch panel including the key identification image display unit and the key tops placed on the key identification image display unit.

According to such an electronic device of the present invention, in the above-mentioned electronic device, the input keys are realized by a touch panel.

Therefore, according to such an electronic device of the present invention, in the above-mentioned electronic device, it is further possible to arbitrarily design the number and arrangement of the input keys, according to the application of the electronic device.

Another electronic device of the present invention is based on the above-mentioned electronic device, and further characterized in that the key identification image display unit is a liquid crystal panel.

According to such an electronic device of the present invention, in the above-mentioned electronic device, the key identification image display unit is realized by a liquid crystal panel.

Therefore, according to such an electronic device of the present invention, in above-mentioned electronic device, it is further possible to arbitrarily design the number and arrangement of the input keys and also the indicators (key identification images) for identifying keys, according to the application of the electronic device.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic view showing schematically the appearance of a mobile terminal as one embodiment of an electronic device of the present invention;

FIG. 2A and FIG. 2B are schematic views showing the detail of an operation unit;

FIG. 3 is a schematic view showing the state in which the display direction is optimized according to the detection result of an attitude detector;

FIG. 4 is a schematic view showing the state in which the display direction is optimized according to the detection result of the attitude detector;

FIG. 5 is a schematic view showing the state in which the display direction is optimized according to the detection result of the attitude detector;

FIG. 6 is a block diagram showing the structure of the essential portion of a control system of the mobile terminal as one embodiment of an electronic device of the present invention;

FIG. 7A is a table explaining the set contents in a display table, and FIG. 7B is a schematic view for explaining a display state corresponding to each set content;

FIG. 8A is a table for explaining the registered contents in a key arrangement table, and FIG. 8B is a schematic diagram showing a corresponding relationship between the key codes assigned to an operation unit;

FIG. 9 is a circuit diagram showing the structure of the attitude detector;

FIG. 10A, FIG. 10B and FIG. 10C are circuit diagrams showing a conductive state between a movable piece and two electrodes when the attitude of the attitude detector is changed;

FIG. 11 is a table showing the corresponding relationship between the detection results of detection units and display styles; and

FIG. 12 is a flowchart explaining the procedure executed by a control unit of the mobile terminal.

### DETAILED DESCRIPTION OF THE PREFERRED EMBODIMENTS

Referring to the drawings, the following description will explain specifically an embodiment in which an electronic device of the present invention is applied to a mobile information terminal device (hereinafter referred to as a mobile terminal), such as a mobile phone and a PDA.

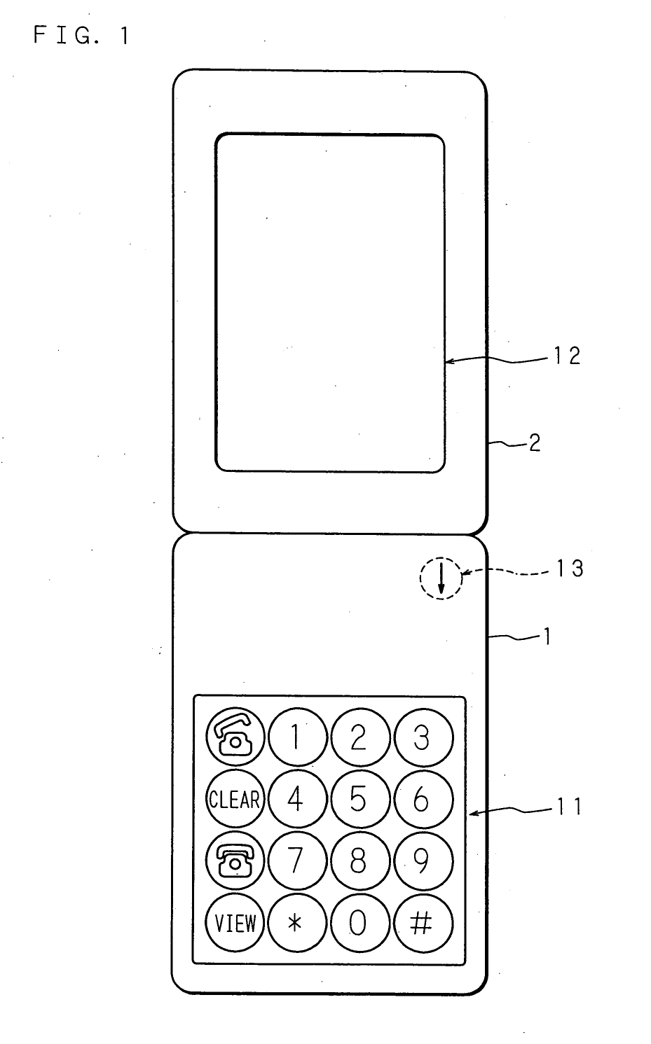

FIG. 1 is a schematic view showing schematically the appearance of a mobile terminal as one embodiment of an electronic device of the present invention. The mobile terminal comprises an operation unit 11 for receiving instruction and operation inputs by a user, and a display unit 12 incorporating an output image display device for displaying an image (output image) outputted based on information inputted through the operation unit 11. The operation unit 11 and the display unit 12 are respectively mounted on panels having a suitable thickness. The two panels are hinged by a hinge member (not shown) and constructed so that the relative angle of the two panels is arbitrarily changed between the folded (in half) state and the approximately 180-degree open state, more specifically the state in which the two panels are almost in a straight line. The panel on which the operation unit 11 is mounted will be hereinafter referred to as an operation unit body 1, and the panel on which the display unit 12 is mounted will be referred to as a display unit body 2.

The operation unit 11 has various input keys arranged in a 4×4 matrix form. The input keys provided by the operation unit 11 include numerical keys, from “0” to “9”, constructed to input predetermined input values, the “*” key and the “#” key in addition to function keys to which predetermined functions are assigned, such as a call key and a clear key.

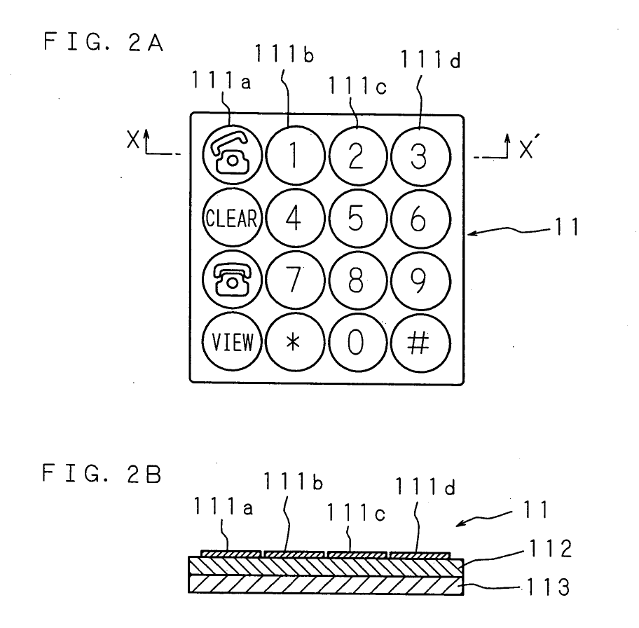

FIG. 2A and FIG. 2B are schematic views showing the detail of the operation unit 11. FIG. 2A shows a plan view of the operation unit 11, and FIG. 2B shows a cross section along the X-X′ line of the plan view of FIG. 2A. For example, for the four input keys in the topmost row of FIG. 2A, as shown specifically in FIG. 2B, key tops (push portions) 111a, 111b, 111c, 111d for receiving push operations by the user are arranged on the operation unit 11, and a push detection unit 112 comprising a semiconductor pressure sensor for detecting push forces applied to the respective key tops 111a, 111b, 111c, and 111d is provided under the positions where the respective key tops are arranged. The push detection unit 112 outputs signals corresponding to the positions of the respective key tops 111a, 111b, 111c and 111d. Note that the input keys other than the above-mentioned four input keys have the same structure, and a signal corresponding to the position of each key top, in other words information indicating a function assigned to each key or a predetermined input value, is outputted when the push detection unit 112 detects the push force applied to each key top.

The key tops 111a, 111b, 111c, 111d, etc. and push detection unit 112 are made of translucent members. It is therefore possible to see an image on an indicator display unit 113 provided under the push detection unit 112. In this embodiment, a liquid crystal display is used as the indicator display unit 113. The indicator display unit 113 is a display device for displaying indicators, that is, key identification images for identifying the respective input keys, corresponding to the positions of the keys tops 111a, 111b, 111c, 111d, etc. In the example shown in FIG. 2A, a key identification image depicting a telephone is displayed corresponding to the position of the key top 111a, and key identification images indicating numerals “1”, “2” and “3” are displayed corresponding to the positions of the key tops 111b, 111c and 111d, respectively. The key identification images assigned to other input keys are basically the same as above.

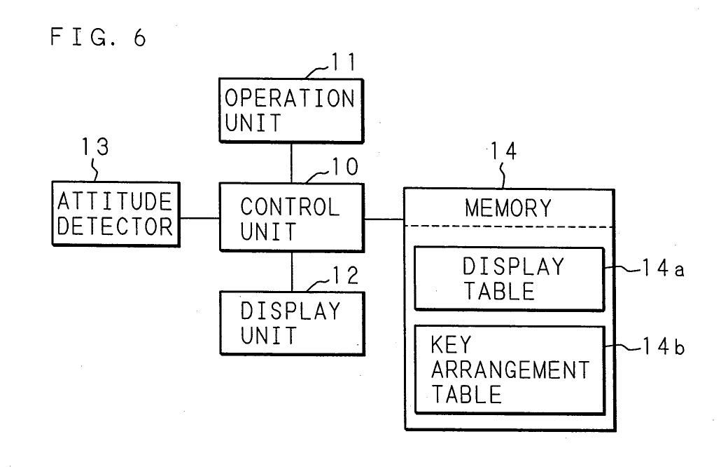

In this embodiment, although the display unit 12 is constructed by a liquid crystal display, it may be possible to construct the display unit 12 by an organic EL display or other display. Note that the display unit 12 displays an image generated by a later-described control unit (see FIG. 6) based on the information inputted through the operation unit 11. Images to be displayed on the display unit 12 include characters, symbols and graphics, and an operation guide and information are informed to the user by displaying such images on the display unit 12.

Moreover, the mobile terminal of this embodiment mounts an attitude detector 13 (see FIG. 1) for detecting its own attitude in the operation unit body 1. The attitude detector 13 is built in so that it is fixed to the operation unit body 1. Therefore, the attitude of the attitude detector 13 becomes the same as the attitude of the operation unit body 1. The mobile terminal optimizes the display direction of the key identification images and the display direction of the image to be displayed on the display unit 12, according to the detection result of the attitude detector 13.

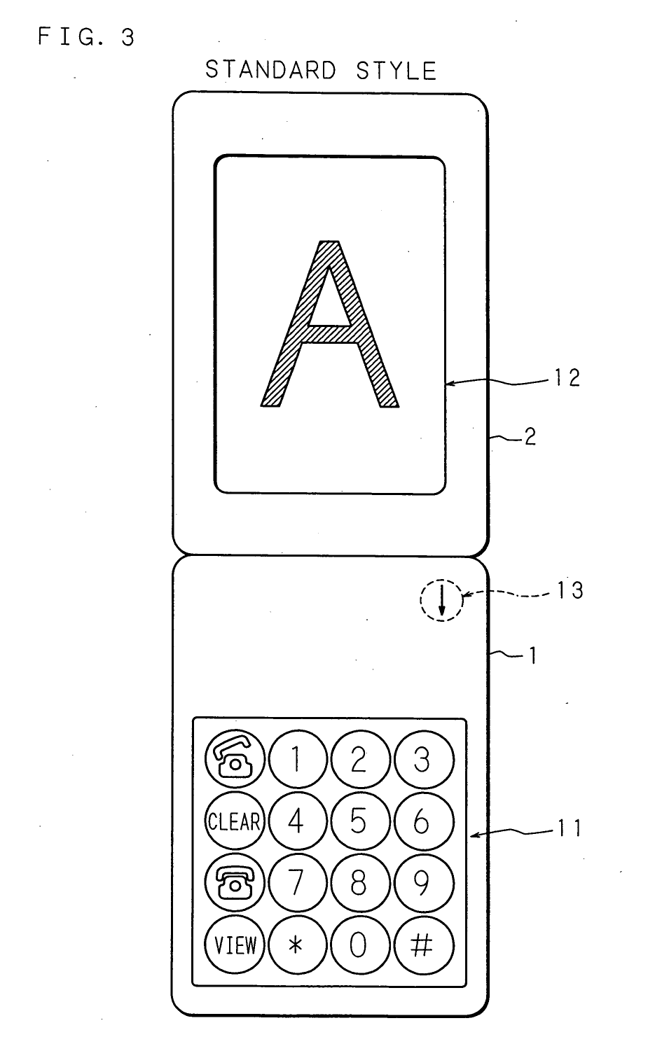

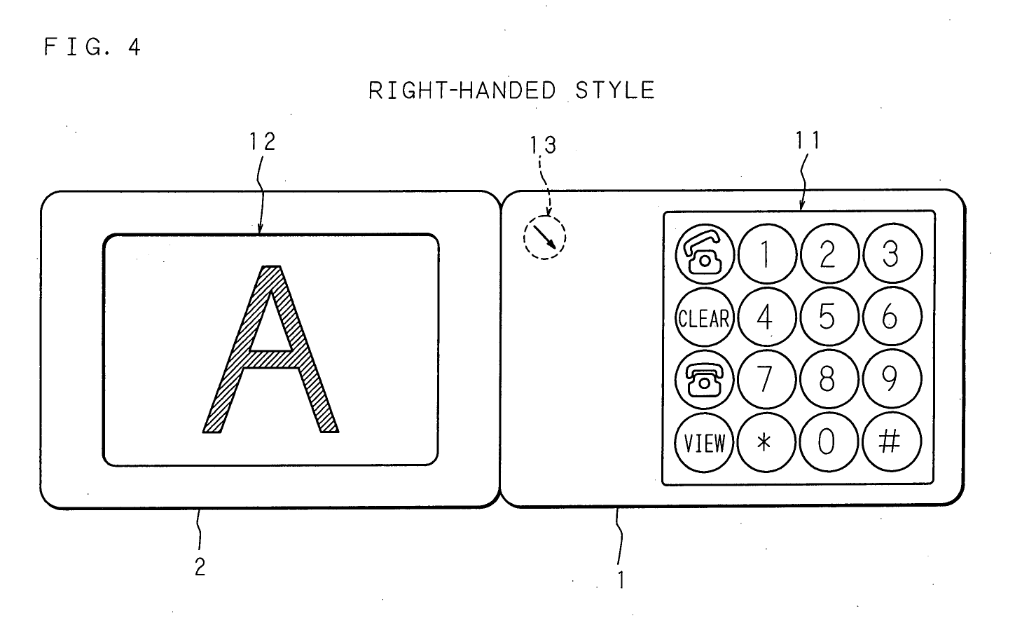

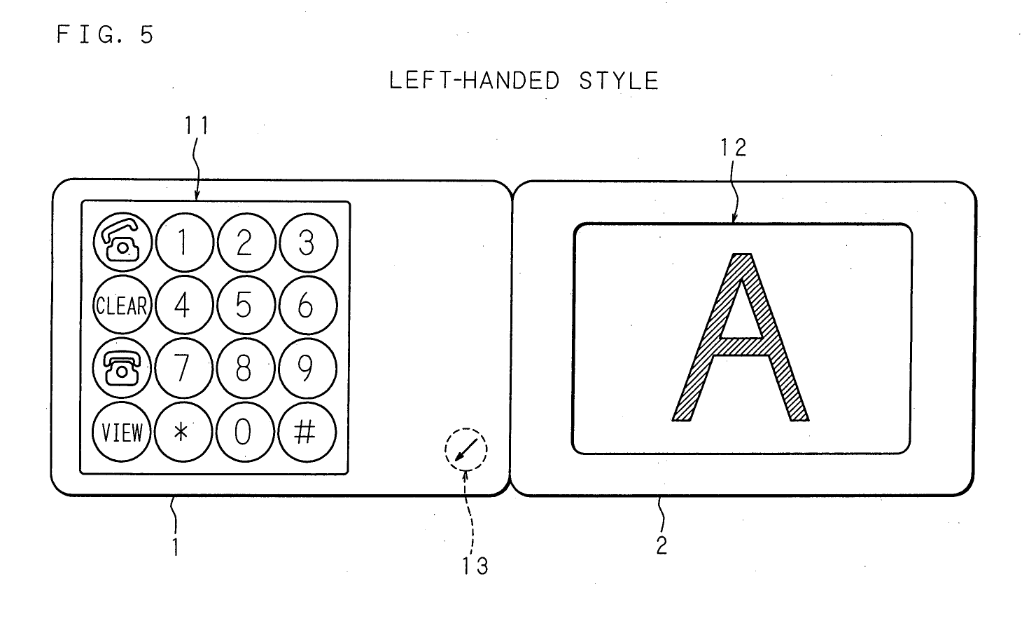

FIG. 3, FIG. 4 and FIG. 5 are schematic views showing the state in which the display directions are optimized according to the detection result of the attitude detector 13. In the case where the positional relation of the display unit body 2 and the operation unit body 1 of the mobile terminal is arranged one above the other (the display unit body 2 is positioned on the upper side and the operation unit body 1 is positioned on the lower side) along a vertical direction, by detecting this state (attitude) by the attitude detector 13, the display directions of both images are set so that the image to be displayed on the display unit 12 and the key identification images to be displayed on the indicator display unit 113 of the operation unit 11 are positioned in the vertical direction (see FIG. 3). In this case, the user holds the operation unit body 1 positioned under the display unit body 2 with his/her right hand or left hand, and operates the mobile terminal. The display style in which the display directions are set so that the display unit body 2 and the operation unit body 1 are arranged in a vertical direction in the above-described manner will be hereinafter refereed to as a standard style.

In the case where the attitude is changed by turning the mobile terminal counterclockwise by approximately 90 degrees in a vertical plane from the state shown in FIG. 3, by detecting the changed state (attitude) by the attitude detector 13, the display directions of both images are set so that the image to be displayed on the display unit 12 is positioned on the left side and the key identification images to be displayed on the indicator display unit 113 of the operation unit 11 are positioned on the right side when seen from the front (see FIG. 4). In this case, the user holds the operation unit body 1 positioned on the right side with respect to the display unit body 2 with his/her right hand, and operates the mobile terminal. The display style in which the display directions are set so that the operation unit body 1 is positioned on the right side of the display unit body 2 in the above-described manner will be hereinafter refereed to as a right-handed style.

On the other hand, in the case where the attitude is changed by turning the mobile terminal clockwise by approximately 90 degrees in a vertical plane from the state shown in FIG. 3, by detecting the changed state (attitude) by the attitude detector 13, the display directions of both images are set so that the image to be displayed on the display unit 12 is positioned on the right side and the key identification images to be displayed on the indicator display unit 113 of the operation unit 11 are positioned on the left side when seen from the front (see FIG. 5). In this case, the user holds the operation unit body 1 positioned on the left side with respect to the display unit body 2 with his/her left hand, and operates the mobile terminal. The display style in which the display directions are set so that the operation unit body 1 is positioned on the left side of the display unit body 2 in the above-described manner will be hereinafter refereed to as a left-handed style.

FIG. 6 is a block diagram showing the structure of the essential portion of the control system of the mobile terminal as one embodiment of an electronic device of the present invention. The mobile terminal comprises a control unit 10, and hardware such as the operation unit 11, display unit 12, attitude detector 13, memory 14, and the like which are connected to the control unit 10. The control unit 10 is composed of a CPU for controlling the above-mentioned hardware devices, a ROM storing a program to be executed by the CPU, a RAM for temporarily storing the calculation results of the CPU, etc., and causes the mobile terminal to function as an electronic device of the present invention when the CPU loads and executes the program stored in the ROM. Although not shown in FIG. 6, the mobile terminal may, of course, comprise a communication device for communicating with external communication devices, a sound output device for outputting sound, etc., according to the application of the mobile terminal.

The operation unit 11 receives an operation by the user inputted by pushing the above-mentioned input key, and sends a signal outputted by the push detection unit 112 according to the position of the operated input key to the control unit 10. The control unit 10 which received the signal outputted from the operation unit 11 executes a process according to the received signal. Examples of processes to be executed by the control unit 10 include the process of generating an image to be displayed on the display unit 12, and the process of executing the function assigned to the input key.

The attitude detector 13 detects its own attitude which is also the attitude of the mobile terminal, and sends the detection result to the control unit 10. The control unit 10 which received the detection result from the attitude detector 13 determines a display style of the image and key identification images, and reads corresponding items from a display table 14a and a key arrangement table 14b in the memory 14 so as to display the image and key identification images according to the determined display style.

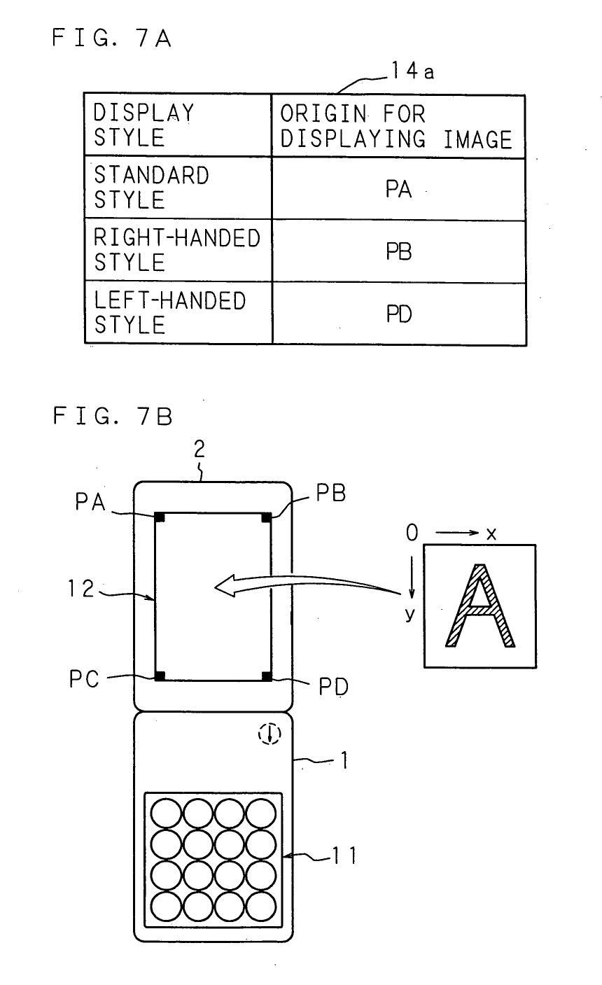

FIG. 7A is a table explaining the set contents in the display table 14a, and FIG. 7B is a schematic view for explaining display states corresponding to the respective set contents. The display table 14a is a table in which each display style is correlated with the origin for displaying an image as shown in FIG. 7A. Here, the origin for displaying an image is a point on the display unit 12 displaying the starting point of the image. In the following description, when the mobile terminal is in the standard style, the point at the upper left corner of the display unit 12 is denoted by PA, the point at the upper right corner is denoted by PB, the point at the lower left corner is denoted by PC, and the point at the lower right corner is denoted by PD.

In the case where an image is displayed in the standard style, the point PA on the display unit 12 is selected as the origin for displaying the image, and the image is displayed by aligning the x direction of the image with a direction running from the point PA to the point PB (see FIG. 7B). On the other hand, in the case where an image is displayed in the right-handed style, the point PB on the display unit 12 is selected as the origin for displaying the image, and the image is displayed by aligning the x direction of the image with a direction running from the point PB to the point PD. Further, in the case where an image is displayed in the left-handed style, the point PC on the display unit 12 is selected as the origin for displaying the image, and the image is displayed by aligning the x direction of the image with a direction running from the point PC to the point PA.

Note that in a case where the size of an image to be displayed differs from the size of the display area of the display unit 12, it may be possible to display the image after performing an enlargement/reduction process, a trimming process, etc. on the image to be displayed.

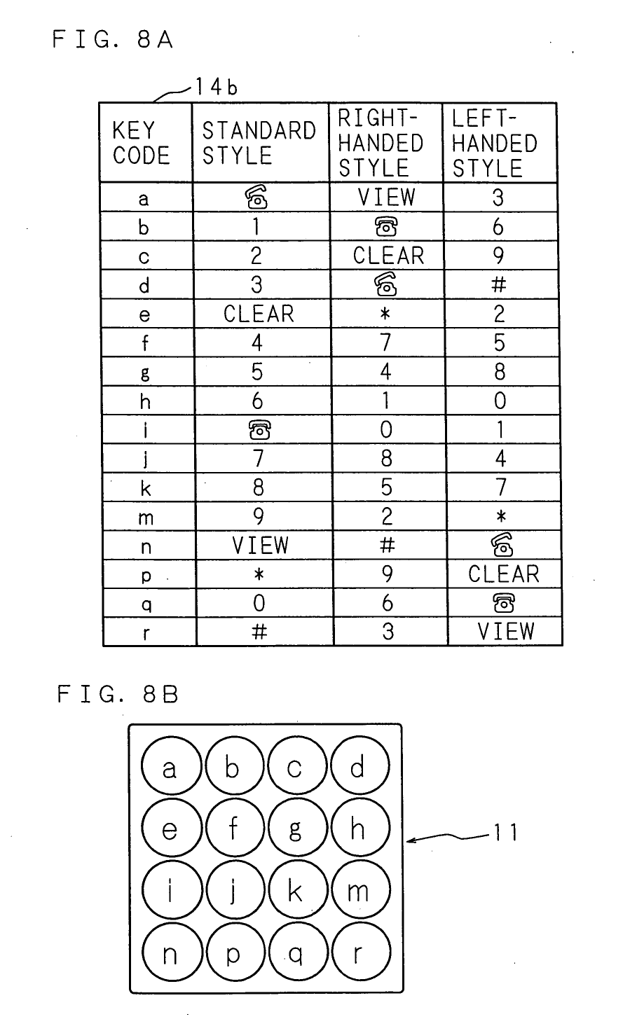

FIG. 8A shows a table for explaining the registered contents in the key arrangement table 14b. In the key arrangement table 14b, key identification images to be assigned to the respective input keys are prescribed for each display style. The corresponding relationship between the key codes assigned to the operation unit 11 as shown in FIG. 8B and the key identification images of each display style are registered beforehand in the key arrangement table 14b. Therefore, by reading the data of a selected display style from the key arrangement table 14b, the control unit 10 determines a key identification image of each input key to be displayed on the indicator display section 13. For example, in a case where the standard style is selected, a key identification image depicting a telephone and key identification images indicating numerals “1”, “2” and “3” are assigned in this order from the left to the input keys in the topmost row (key codes are a, b, c and d), respectively. For the second and following rows, key identification images are assigned in the same manner. In a case where the right-handed style is selected, key identification images to which key codes d, h, m and r are given in the key arrangement table 14b are selected as the key identification images to be assigned to the input keys in the topmost row. Similarly, in a case where the left-handed style is selected, key identification images to which key codes n, i, e and a are given in the key arrangement table 14b are selected as the key identification images to be assigned to the input keys in the topmost row.

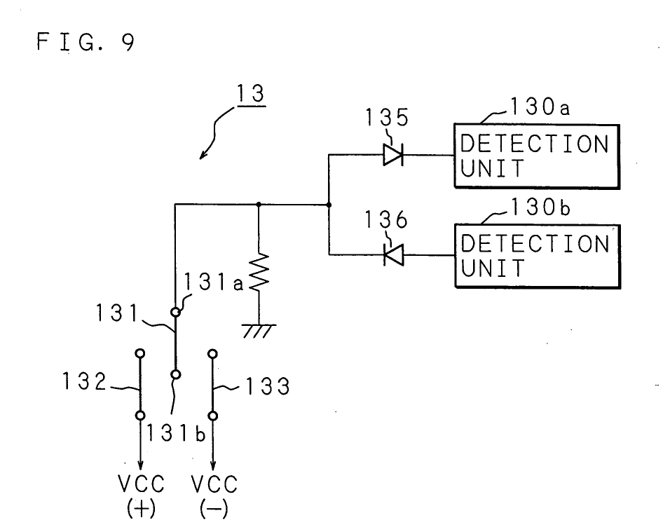

FIG. 9 is a circuit diagram showing the structure of the attitude detector 13. The attitude detector 13 comprises a conductive movable piece 131 moving according to the attitude of the operation unit body 1, that is, the attitude of the attitude detector 13 itself, an electrode connected to the positive electrode side of a power source VCC for the attitude detector 13; and an electrode 133 connected to the negative electrode side of the same. The movable piece 131 and the two electrodes 132 and 133 are arranged in the same plane, and the movable piece 131 is supported so that it can turn round a supporting point 131a in the same plane as the electrodes 132 and 133. Therefore, when the movable piece 13 turns clockwise by a predetermined angle on FIG. 9, an end portion 131b of the movable piece 131 comes into contact with the electrode 132. On the other hand, when the movable piece 131 turns counterclockwise by a predetermined angle, the end portion 131b comes into contact with the electrode 133.

Two detection units 130a and 130b for detecting a current are connected to the supporting point 131a side of the movable piece 131 through diodes 135 and 136, respectively. As shown in the circuit diagram of FIG. 9, since the detection unit 130a is connected to the cathode side of the diode 135, it is possible to detect a current flowing when the end portion 131b of the movable piece 131 comes into contact with the electrode 132 (positive electrode). Moreover, since the detection unit 130b is connected to the anode side of the diode 136, it is possible to detect a current flowing when the end portion 131b of the movable piece 131 comes into contact with the electrode 133 (negative electrode). Each of the detection units 130a and 130b outputs an ON signal when it detects a current, or outputs an OFF signal when it cannot detect a current.

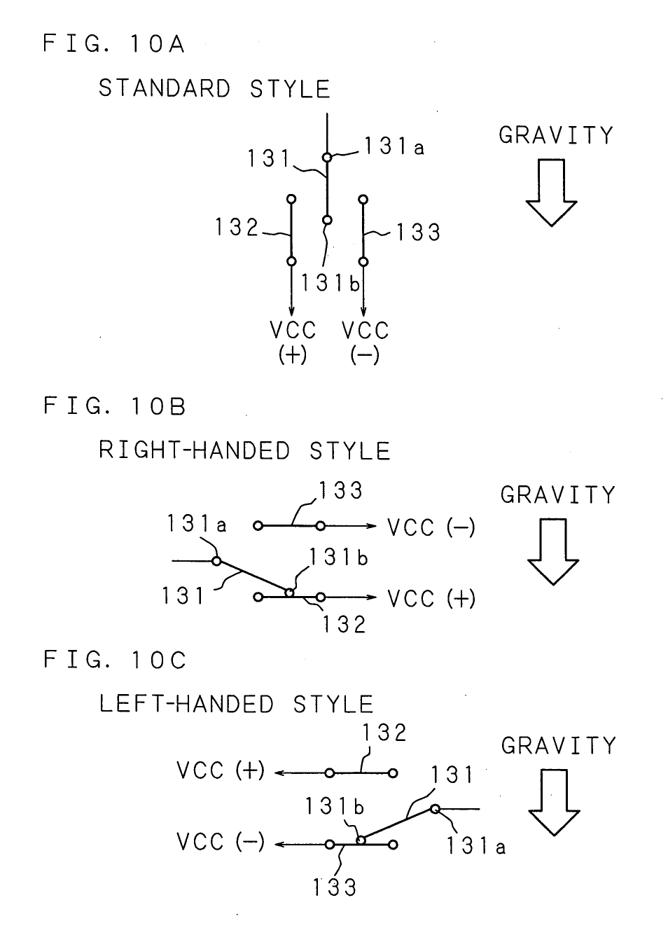

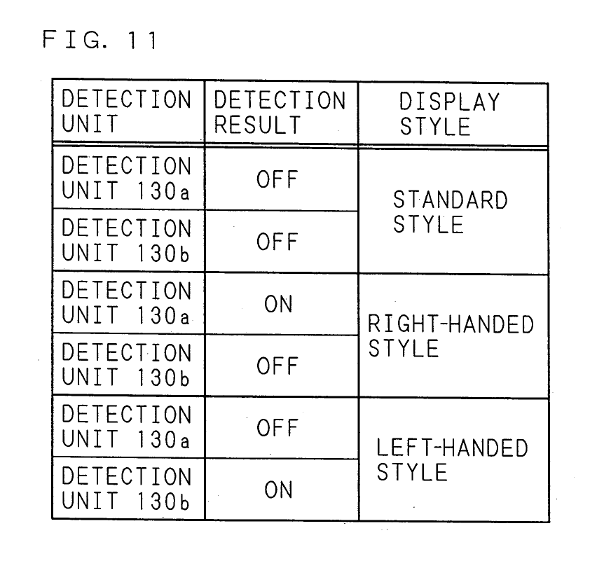

FIG. 10A, FIG. 10B and FIG. 10C are circuit diagrams showing the conductive state between the movable piece 131 and the two electrodes 132 and 133 when the attitude of the attitude detector 13 is changed. FIG. 11 is a table showing the corresponding relationship between the detection results of the detection units 130a and 130b and the display styles. Note that the white arrows shown in FIG. 10A, FIG. 10B and FIG. 10C indicate the direction of gravity applied to the attitude detector 13.

In the case where the positional relation of the display unit body 2 and the operation unit body 1 of the mobile terminal is arranged one above the other along a vertical direction, as shown in FIG. 10A, the end portion 131b of the movable piece 131 does not come into contact with either the electrode 132 or 133. In this case, since both of the two detection units 130a and 130b output OFF signals, the control unit 10 which received the detection result of the attitude detector 13 selects the standard style as a display style of the image and key identification images. In the case where the mobile terminal is turned counterclockwise by approximately 90 degrees in a vertical plane from the state shown in FIG. 10A, the movable piece 131 turns round the supporting point 131a due to its self-weight and comes into contact with the electrode 132 as shown in FIG. 10B, and consequently the detection unit 130a outputs an ON signal and the detection unit 130b outputs an OFF signal. By receiving these detection results, the control unit 10 selects the right-handed style as a display style of the image and key identification images. On the other hand, in the case where the mobile terminal is turned clockwise by approximately 90 degrees in a vertical plane from the state shown in FIG. 10A, the movable piece 131 turns round the supporting point 131a due to its self-weight and comes into contact with the electrode 133 as shown in FIG. 10C, and consequently the detection unit 130a outputs an OFF signal and the detection unit 130b outputs an ON signal. By receiving these detection results, the control unit 10 selects the left-handed style as a display style of the image and key identification images.

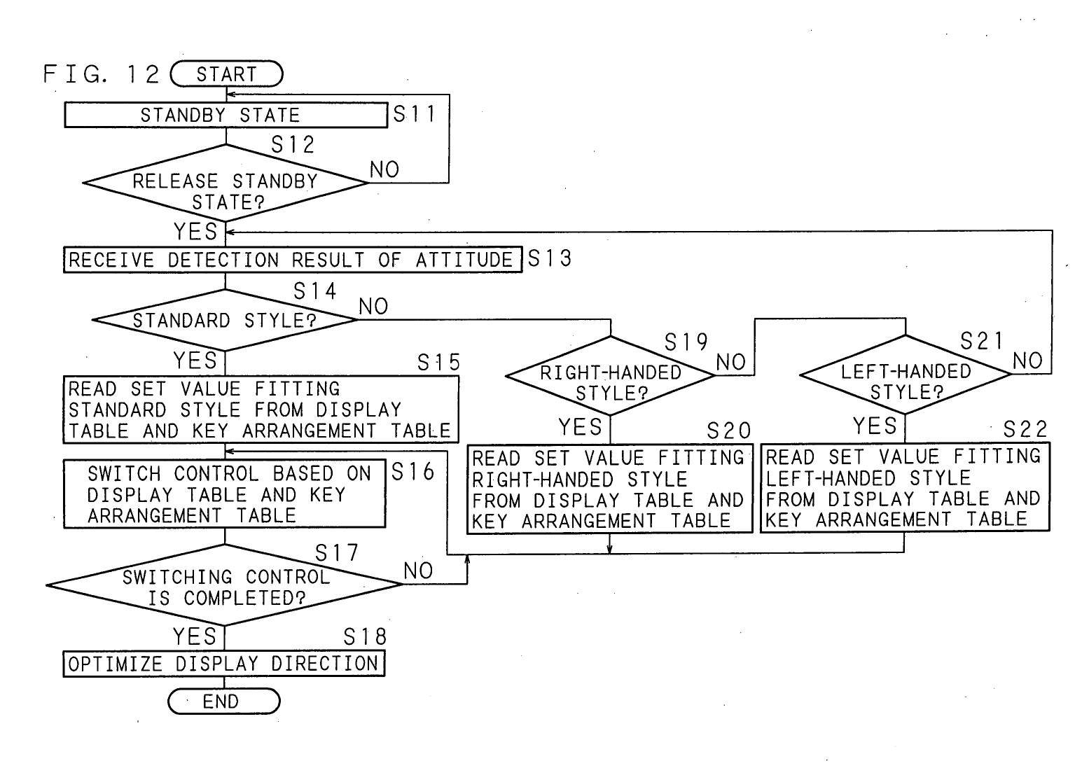

The following description will explain the procedure executed by the mobile terminal. FIG. 12 is a flowchart explaining the procedure executed by the control unit 10 of the mobile terminal. Note that the following processes are executed by the control unit 10 according to the pre-stored program in the ROM.

When the mobile terminal is in a standby state to receive an operation by the user (step S11), the control unit 10 determines whether or not the standby state has been released (step S12). The determination as to whether or not the standby state has been released can be made by detecting whether or not the operation unit body 1 and the display unit body 2 have moved from the folded (in half) state into the approximately 180-degree open state, that is, the state in which they are in a straight line. When the control unit 10 determines that the standby state has not been released (S12: NO), it returns the process to step S11.

When the standby state has been released (S12: YES), the control unit 10 receives the detection result of detecting the attitude by the attitude detector 13 (step S13). The control unit 10 determines, based on the detection result of the attitude detector 13, whether or not the detection result indicates the standard style (step S14). In other words, the control unit 10 determines whether or not the two detection units 130a and 130b of the attitude detector 13 are both off.

When the control unit 10 determines that the detection result indicates the standard style (S14: YES), the control unit 10 reads the set values fitting the standard style from the display table 14a and the key arrangement table 14b (step S15), and generates an image to be displayed on the display unit 12 and key identification images to be displayed on the indicator display unit 113. Next, the control unit 10 switches control based on the registered contents in the display table 14a and the key arrangement table 14b (step S16). At switching control, the control unit 10 assigns control fitting the standard style to a signal outputted from the push detection unit 112. For example, in order to cause the input key corresponding to the key code “a” shown in FIG. 8A to function as the call key, the control unit 10 correlates control executed by the control unit 10 with a signal outputted by the push detection unit 112 when the key top corresponding to the key code “a” is pushed. The same operation is also performed for the input keys corresponding to the other key codes “b” to “r”.

Next, the control unit 10 determines whether or not switching of control has been completed (step S17). When the control unit 10 determines that switching of control has not been completed (S17: NO), it waits until the switching of control has been completed. When the control unit 10 determines that switching of control has been completed (S17: YES), it optimizes the display direction by displaying the image and key identification images generated based on the set values read at step S15 on the display unit 12 and the indicator display unit 113, respectively (step S18).

On the other hand, at step S14, when the control unit 10 determines that the detection result of the attitude detector 13 did not indicate the standard style (S14: NO), it determines whether or not the detection result indicates the right-handed style (step S19). When the control unit 10 determines that the detection result of the attitude detector 13 indicates the right-handed style (S19: YES), it reads the set values fitting the right-handed style from the display table 14a and the key arrangement table 14b (step S20), and generates an image to be displayed on the display unit 2 and key identification images to be displayed on the indicator display unit 113 of the operation unit 11. Then, the control unit 10 executes the above-mentioned processes of steps S16, S17 and S18, and optimizes the display direction of the image to be displayed on the display unit 12 and the key identification images to be displayed on the indicator display unit 113 of the operation unit 11.

On the other hand, at step S19, when the control unit 10 determines that the detection result of the attitude detector 13 did not indicate the right-handed style (S19: NO), it determines whether or not the detection result indicates the left-handed style (step S21). When the control unit 10 determines that the detection result of the attitude detector 13 did not indicate the left-handed style (S21: NO), it returns process to step S13 and executes attitude detection by the attitude detector 13 again. On the other hand, when the control unit 10 determines that the detection result of the attitude detector 13 indicates the left-handed style (S21: YES), it reads the set values fitting the left-handed style from the display table 14a and the key arrangement table 14b (step S22), and generates an image to be displayed on the display unit 12 and key identification images to be displayed on the indicator display unit 113 of the operation unit 11. Then, the control unit 10 executes the above-mentioned processes of steps S16, S17 and S18, and optimizes the display direction of the image to be displayed on the display unit 12 and the key identification images to be displayed on the indicator display unit 113 of the operation unit 11.

Note that, in this embodiment, the display direction of the key identification images in the operation unit 11 and the display direction of the image in the display unit 12 are optimized by causing the attitude detector 13 to detect its own attitude when the standby state is released. However, it may, of course, be possible to optimize the display direction all the time by causing the attitude detector 13 to always detect its own attitude. Moreover, in this embodiment, the attitudes in three states are detected by the attitude detector 13. However, by changing the number of electrodes disposed in the movable range of the movable piece 131 to two, four or more, it is, of course, possible to optimize the display direction according to the attitudes in two, four or more states.

Further, in this embodiment, although the input keys are arranged in a 4×4 matrix form, the number and arrangement of the input keys are not restricted.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An electronic device which comprises: a key identification image display unit displaying key identification images for identifying input keys; one or a plurality of key tops arranged on said key identification image display unit and formed so that a display shown by said key identification display unit is visible; and a control unit for causing key identification images for identifying said respective key tops to be displayed on said key identification image display unit according to positions where said respective key tops are arranged on said key identification image display unit and for performing a process according to information inputted by pushing said key top, said electronic device further comprising an attitude detector for detecting its own attitude,
wherein said control unit sets a display style of said key identification images based on detection result of said attitude detector, and displays said key identification images in the set display style.

2. The electronic device as set forth in claim 1, wherein said attitude detector comprises:
at least one electrode connected to a power source;
a conductive movable piece moving in a movable range in which it is capable of coming into contact with said electrode, according to a change of the attitude; and
a detection circuit for detecting a conductive state between said electrode and said movable piece,
whereby said attitude detector detects its own attitude based on said conductive state detected by said detection circuit.

3. The electronic device as set forth in claim 2, further comprising a memory for storing a plurality of sets of corresponding relationship between said respective key tops and key identification images assigned to said respective key tops, which prescribe display styles of said key identification images,
wherein said control unit selects one set of corresponding relationship stored in said memory based on the detection result of said attitude detector, and sets a display style of said key identification images according to the selected corresponding relationship.

4. The electronic device as set forth in claim 3, further comprising a touch panel including said key identification image display unit and said key tops placed on said key identification image display unit.

5. The electronic device as set forth in claim 4, wherein said key identification image display unit is a liquid crystal panel.

6. The electronic device as set forth in claim 1, further comprising an output image display unit for displaying an output image outputted based on information inputted by pushing said key top,
wherein said control unit generates said output image based on said information inputted by pushing said key top, sets a display style of said output image on said output image display unit based on said detection result of said attitude detector, and displays the generated output image in the set display style on said output image display unit.

7. The electronic device as set forth in claim 6, wherein said attitude detector comprises:
at least one electrode connected to a power source;
a conductive movable piece moving in a movable range in which it is capable of coming into contact with said electrode, according to a change of its own attitude; and
a detection circuit for detecting a conductive state between said electrode and said movable piece,
whereby said attitude detector detects its own attitude based on said conductive state detected by said detection circuit.

8. The electronic device as set forth in claim 7, wherein, when said detection circuit detects that said electrode and said movable piece are conductive state, said control unit sets a display style of said key identification images and said output image so that said key identification images and said output image are displayed on said key identification image display unit and said output image display unit, respectively, in a predetermined positional relationship.

9. The electronic device as set forth in claim 8, wherein, when said detection circuit detects that said electrode and said movable piece are not conductive state, said control unit sets a display style of said key identification images and said output image so that said key identification images and said output image are displayed on said key identification image display unit and said output image display unit, respectively, in a positional relationship different from said predetermined positional relationship.

10. The electronic device as set forth in claim 9, further comprising a memory for storing a plurality of sets of corresponding relationship between said respective key tops and key identification images assigned to said respective key tops, which prescribe display styles of said key identification images,
wherein said control unit selects one set of corresponding relationship stored in said memory based on the detection result of said attitude detector, and sets a display style of said key identification images according to the selected corresponding relationship.

11. The electronic device as set forth in claim 10, wherein said display style of said output image is regulated by rotating, enlarging or reducing said output image.

12. The electronic device as set forth in claim 11, further comprising a touch panel including said key identification image display unit and said key tops placed on said key identification image display unit.

13. The electronic device as set forth in claim 12, wherein said key identification image display unit is a liquid crystal panel.
